(19) United States
(12) Patent Application Publication
(10) Pub. No.: US 2016/0003685 A1
(43) Pub. Date: Jan. 7, 2016

(54) Mounting Apparatus for Temperature Sensor

(71) Applicants: Vareck Walla, Katy, TX (US); Rhett Walla, Katy, TX (US); Richard Walla, Katy, TX (US)

(72) Inventors: Vareck Walla, Katy, TX (US); Rhett Walla, Katy, TX (US); Richard Walla, Katy, TX (US)

(21) Appl. No.: 14/323,483

(22) Filed: Jul. 3, 2014

(51) Int. Cl. G01K 1/14

(52) U.S. Cl. CPC G01K 1/143

(57) ABSTRACT

A mounting apparatus for a temperature sensor assembly for sensing skin temperature of a tubular member which has a ceramic collar in surrounding relationship to the tubular member, the collar having a throughbore. There is a metallic mount removably secured to the collar which has an opening in register with the throughbore in the collar. The mount includes a connector for attaching to a temperature sensor assembly.

### FIELD OF THE INVENTION

The present invention relates to monitoring skin temperature of a tubular member in which a hot fluid is flowing. More particularly, the present invention relates to a mounting apparatus for a temperature sensor assembly for sensing the skin temperature of the tubular member.

### BACKGROUND OF THE INVENTION

A fired heater is a direct-fired heat exchanger that uses the hot gases of combustion to raise the temperature of a feed flowing through coils of tubes aligned throughout the heater. Depending on the use, these are also called furnaces or process heaters. Some heaters simply deliver the feed at a predetermined temperature to the next stage of the reaction process; others perform reactions on the feed while it travels through the tubes.

Fired heaters are used throughout the hydrocarbon and chemical processing industries such as refineries, gas plants, petrochemicals, chemicals and synthetics, olefins, ammonia and fertilizer plants. Most of the unit operations require one or more fired heaters, as a startup heater, fired reboiler, cracking furnace, process heater, process heater vaporizer, crude oil heater or reformer furnace.

For production, safety and quality control, to name a few, it is often necessary to measure the skin temperature of tubes entering, within and exiting a heat source in a consistent and coincident manner. For example in the chemical processing industry, these temperatures can range from hundreds to thousands of degrees Fahrenheit. Furthermore, the nature of the heat generating furnaces/heaters is that they are often subject to vibration. This characteristic complicates fixed temperature sensors from taking consistent measurements; for example humans taking the temperature with a hand-held temperature “gun” consistently have an issue with pointing the laser at the same spot every time. In this regard most thermocouples measure temperature via the institution of a laser that points at the item being measured. Consistent measurements demand that this laser point be placed at almost exactly the same spot when taking a temperature reading so as to obtain consistent and comparable results. Coupled with the fact that very often the tubes, the skin temperatures of which are to be measured, are outside and therefore are exposed to adverse weather conditions, the apparatus employed to take the skin temperature must be somewhat resistant to weather elements e.g., wind, rain, snow etc.

### SUMMARY OF THE INVENTION

In one aspect the present invention provides a mounting apparatus for a temperature sensor assembly.

In another aspect the present invention relates to a mounting apparatus for a temperature sensor assembly which is heat and weather resistant.

In still another aspect the present invention provides a mounting apparatus for a temperature sensor assembly which can measure the skin temperature of a metallic body e.g, a tubular member in which is contained a hot fluid.

In still a further aspect, the present invention provides a mounting apparatus for a temperature sensor assembly wherein the temperature sensor assembly is maintained in a fixed position relative to the surface of a metallic body e.g., a tubular member in which a hot fluid is flowing.

These and further features and advantages of the present invention will become apparent from the following detailed description, wherein reference is made to the figures in the accompanying drawings.

### BRIEF DESCRIPTION OF THE DRAWINGS

FIG. 1 is an elevational view, partly in section, showing schematically the convection box of a typical direct fired furnace or heater.

FIG. 2 is an enlarged, elevational view, partly in section, showing the mounting apparatus of the present invention connected to the furnace of FIG. 1.

FIG. 3 is a cross-sectional view taken along the lines 3-3 of FIG. 2.

FIG. 4 is an elevational view, partly in section, showing details of the mounting assembly of the present invention.

FIG. 5 is a cross-sectional view taken along the lines 5-5 of FIG. 4.

FIG. 6 is a cross-sectional view taken along the lines 6-6 of FIG. 4.

FIG. 7 is a view similar to FIG. 2 but rotated 90° from the view shown in FIG. 2.

FIG. 8 is a cross-sectional view taken along the lines 8-8 of FIG. 2 and

FIG. 9 is a cross-sectional view of another embodiment of the present invention showing the use of mounting apparatus of the present invention with metallic tubular members.

### DETAILED DESCRIPTION OF PREFERRED EMBODIMENTS

The term “collar” as used herein refers to any structure which encircles at least one tubular member and can include a structure which itself is not necessarily circular when viewed in cross-section i.e., it is not necessarily an annular body, but which has one or more openings therethrough in which can be received one or more tubular members.

While in the description which follows, the mounting apparatus of the present invention will be described with respect to the use of an outer wrap, sheath or jacket which is heat and weather resistant, it is to be understood that the invention is not so limited. There may be circumstances when such a weather proof wrap is unnecessary. Further, while the invention will be described with reference to the inlet/outlet tube of the convection section of a typical gas fired heater/furnace, it will be understood that it is not so limited. For example, the mounting apparatus of the present invention could be used on the inlet/outlet tubes of the radiant section of the heater/furnace. Moreover, it will be apparent that the present invention can be used to mount any sort of temperature sensing or temperature sensor assembly on any conduit through which heated fluids/slurries etc. are being transported. Thus, the word “tubular” or variants thereof is not intended to be limited to a conduit or the like having a circular cross section as opposed to any conduit, regardless of its cross sectional configuration.

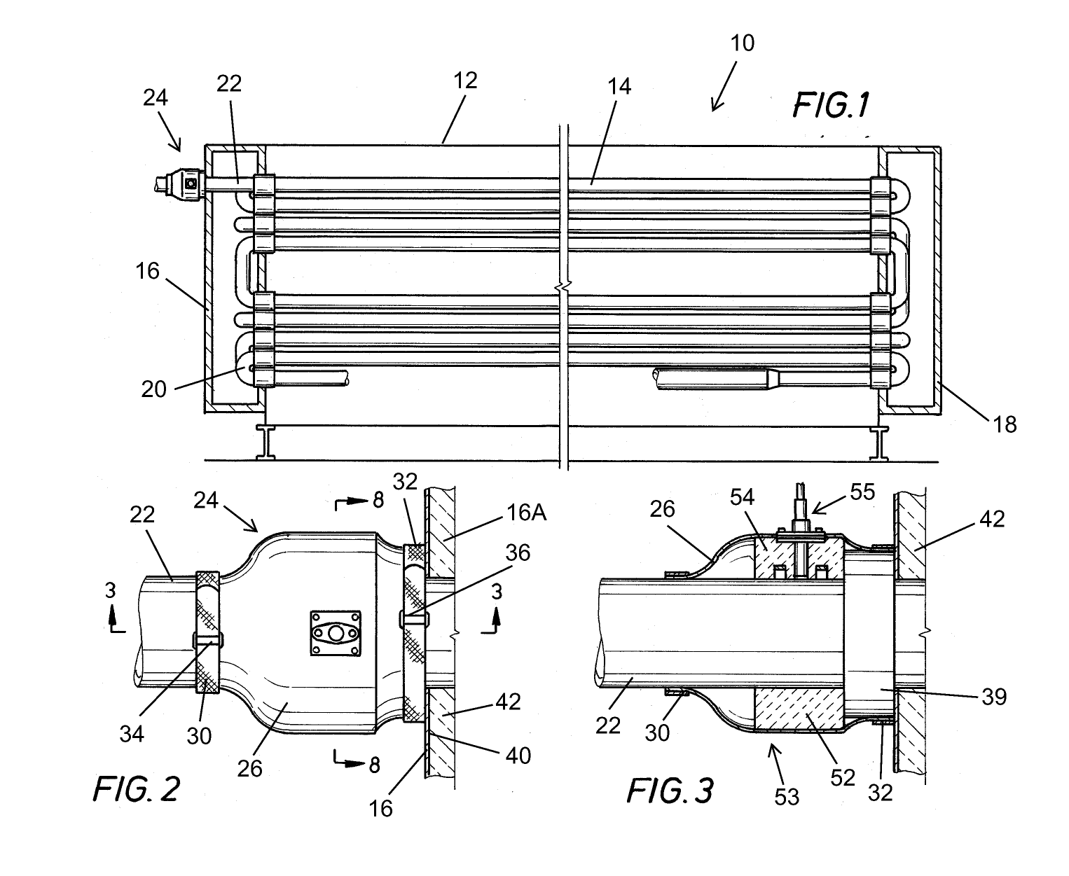

Referring first to FIG. 1 there is shown schematically the convection box or section, shown generally as 10 of a typical direct fired furnace. It will be understood that a complete direct fired furnace would also include a radiant section as is well known to those skilled in the art. Convection box 10 comprises a housing 12 in which are disposed one or more tubes 14 which can comprise a single tube in serpentine fashion or multiple tubes in various arrays. At either end of housing 12 are first and second header boxes 16 and 18 into which project U-shaped joints 20 which connect respective tubes 14 together. There is a tube 22 which can be an inlet or an outlet tube which projects out of header box 16 on which the mounting apparatus of the present invention, shown generally as 24 is positioned.

It will be appreciated that while in the embodiment shown in FIG. 1 only a single tube 22 is shown exiting/entering convection box 10, it will be appreciated that in most cases there are multiple such tubes all of which have flowing through them a high temperature fluid and most or all of which require monitoring of the skin temperature by suitable thermocouples or other temperature sensing apparatus.

Referring now to FIGS. 2, 3, 7 and 8 there are shown in greater detail the mounting apparatus of the present invention attached to a tube e.g., tube 22. Apparatus 24 includes an outer, flexible sheath or wrap 26 designed to be releasably fitted onto and off of apparatus 24 and described hereafter. Wrap 26 can be multi-layered and made of various heat resistant and weather resistant fabrics, fibers, woven materials, etc. A typical inner layer 26A can comprise Nextel® ceramic fabric marketed by 3M. Depending upon the temperatures to be measured, other high temperature textiles such as aramids, carbon, glass or quartz can be employed; however for very high temperatures such as generally encountered in direct fired furnaces, Nextel® fabric or a similar ceramic fabric is generally preferred. The middle layer 26B of wrap 26 generally comprises a suitable ceramic fiber as for example an aluminosilicate ceramic fiber or the like typically employed in insulating applications. Lastly, wrap 26 comprises an outer, weather resistant layer 26C which can be comprised of a number of materials but which can be a silicone impregnated cloth which is weather resistant. Thus, wrap 26 has an inner and middle layer which act to resist heat transfer and an outer layer which provides a water proof barrier for the inner most portions of apparatus 24.

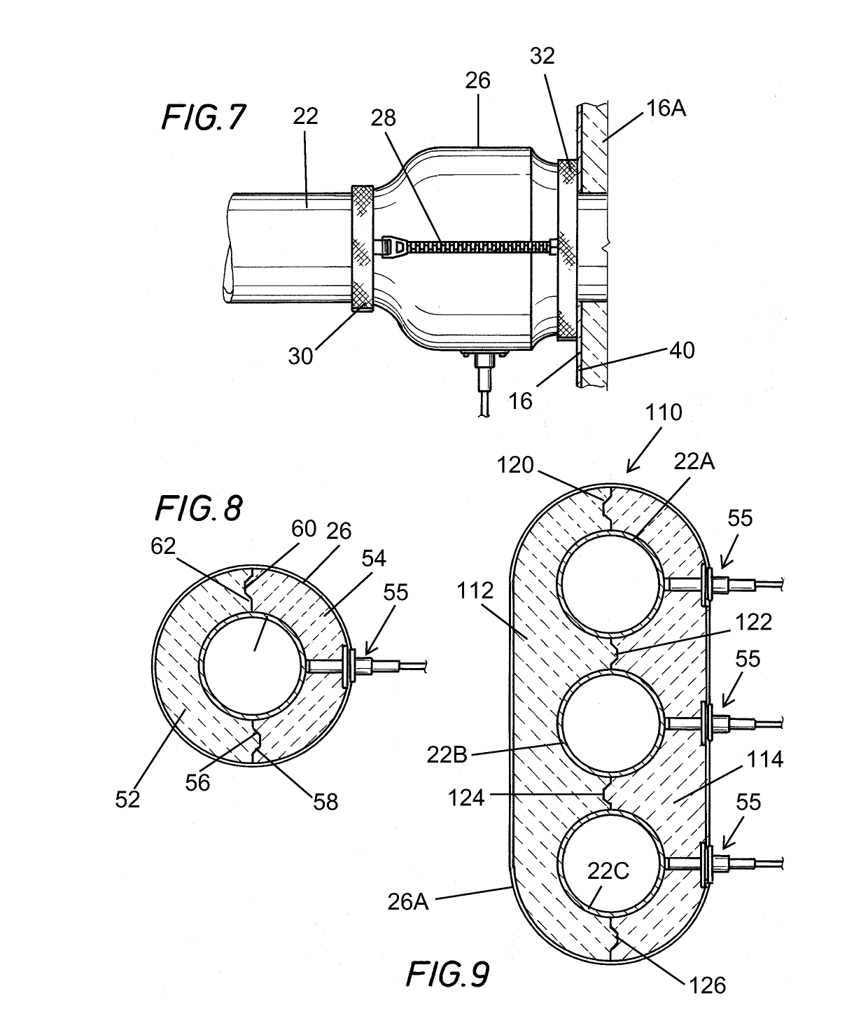

As best seen with reference to FIGS. 2 and 7, wrap 26 has a fastener e.g., a zipper 28, which runs length wise of wrap 26 such that when wrap 26 is positioned around a tubular member such as tubular member 22, the fastener can be engaged to hold the two edges of the wrap 26 together. It will be understood that other types of fasteners such as Velcro® fabric, hooks and eyes, snaps etc. can be employed provided they possess the ability to keep out rain, snow and the like from inside wrap 26.

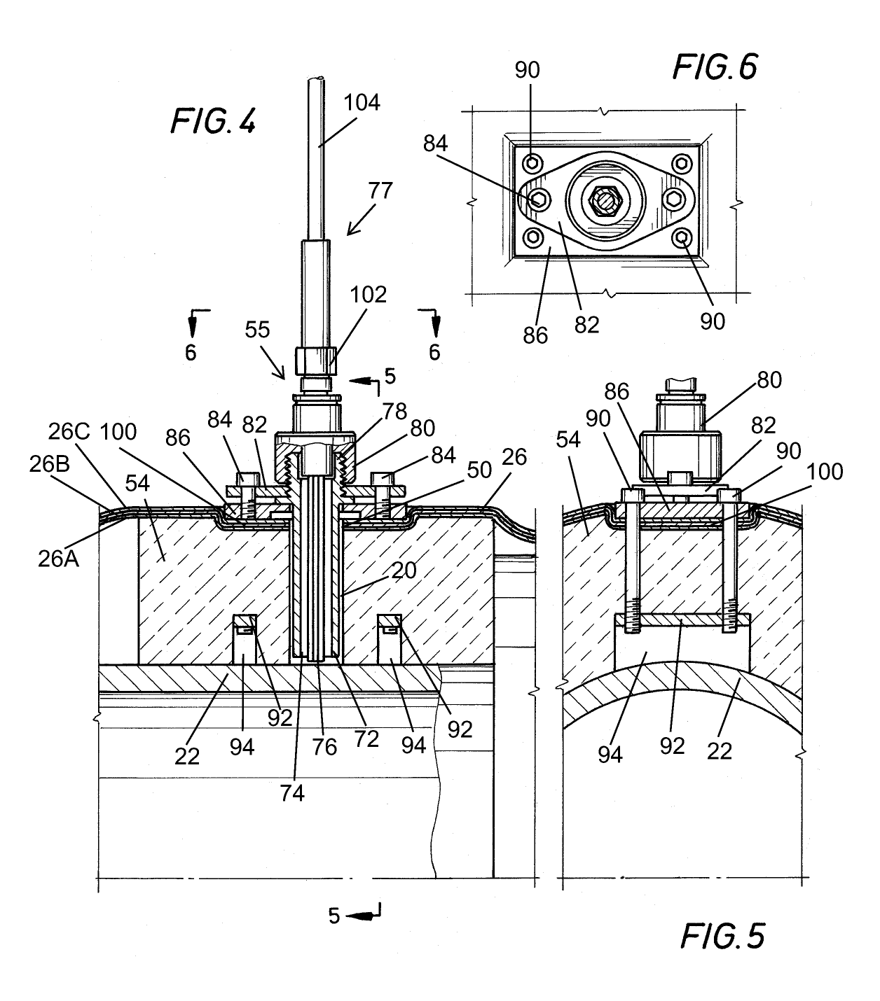

To hold wrap 26 securely onto tubular member 22, wrap 26 is provided with straps 30 and 32 on opposite ends of wrap 26, straps 30 and 32 being provided with D-rings 34 and 36, respectively, for size adjustability. In this regard it should be noted as best seen in FIG. 3, tube 22 mates to a flange 39 forming an outlet from convection box 12, flange 39 having a larger OD then the OD of tube 22. It should also be noted that it to the extent possible, it is desired that the temperature measurement of the skin temperature of tube 22 be taken as close as possible to the outlet of the convection box 12 so as to know with the greatest accuracy possible the temperature of the fluid in tube 22 entering or leaving convection box 12. As seen, in the details shown in FIGS. 2, 3 and 7, header box 16 has a metallic wall 40 lined with insulation 42 in the well known manner. Wrap 26 has an orifice (see FIG. 4) for use in a manner described hereafter.

Referring now to FIGS. 4, 5, 6, and 8, more details of the mounting apparatus of the present invention are shown. As seen in FIG. 8, in one embodiment the present invention comprises first and second segments or portions 52 and 54 of a heat resistant ceramic or refractory material. As seen, segments 52 and 54 cooperate to form a collar, shown generally as 53. Although not necessary, segments 52 and 54 have interengagable formations projecting as to one and receiving as to the other such that when the segments 52 and 54 are brought together the formations engage and restrain any relative radial movement between segments 52 and 54. Thus, segment 52 has a projecting formation 56 which engages a receiving formation 58 formed on segment 54 while segment 54 has a projecting formation 60 which is received in a receiving formation 62 in segment 52. While the abutting faces of the segments 52 and 54 could be substantially planar, for ease of assembly it is preferable that such engagable formations be formed on the abutting faces of the segments.

Various types of refractory materials can be employed to make the collars of the present invention. As known to those skilled in the art, refractories can generally be classified as acid refractory materials, natural refractory materials, and basic refractory materials. Generally speaking, the environment in which the apparatus of the present invention is used will dictate the type of refractory material used in manufacturing the collar. As is known to those skilled in the art, since the collars of the present invention, are formed objects, as opposed to unformed granulated or plastic compositions, the raw materials selected to form the collars are mixed and formed into the desired shape, either via vacuum forming or thermoforming processes well known to those skilled in the art. In some cases, the thus formed product can be milled, ground, or sandblasted to achieve the precise size and shape desired.

In cases where the collar formed by segments 52 and 54 was not exposed to the elements e.g., if apparatus 24 extended into an enclosure for some reason and thus a weather resistant wrap such as wrap 26 was not needed, segments 52 and 54 could be held in place by means of one or more bands of a suitable material which encircled the segments to maintain the collar formed by the segments intact. It will also be appreciated that other means of connecting segments 52 and 54 could be employed as for example by the use of nut and bolt assemblies received through registering bores in segments 52 and 54.

Referring now to FIG. 4 there is a throughbore 70 which extends through segment 54. Received in throughbore 70 is a tube 72 which forms a well 74 in which is received a temperature probe 76 having part of a temperature sensor assembly shown generally as 55 and described more fully hereafter. Well tube 72 has an upper, externally threaded end 78, threaded end 78 being threadedly received in a cap 80 forming part of the temperature sensor assembly 55. As can also be seen from FIG. 4, threaded end 78 is also threadedly received in a threaded opening of a mounting plate 82. Mounting plate 82 is secured via bolts 84 to an anchor plate 86 having threaded holes for threadedly receiving bolts 84. One end of anchor plate 86 is secured to segment 54 of the ceramic collar by means of a first pair of bolts 90 which extend through holes in anchor plate 86 and a first set of bores in segment 54, the threaded ends of bolts 90 being threadedly attached to a locking bar 92 positioned in a first radially inwardly extending recess 94 in segment 54. In like manner, a second set of bolts 90 extend through a second set of holes on the opposite end of anchor plate 86, and a second set of bores in segment 54 and are threadedly connected to a second locking bar 92 received in a second radially, inwardly extending recess in segment 54.

As can be seen, orifice 50 in sheath 26 is in register with throughbore 70 in segment 54 as well as the openings in anchor plate 86 and mounting plate 82. It should also be noted that orifice 50 in jacket 26 is formed in a portion of jacket 26 which is received in a depression 100 formed in the outer surface of segment 54.

Temperature sensor assembly 55 includes a compression fitting 102 which connects a lead 104 to housing/cap 78, lead 104 being attached in a well known manner to a readout/recording system e.g., a computer, recorder, gauge or the like which shows and/or records the temperature detected by probe 76.

Referring now to FIG. 9, there is shown another embodiment of the present invention wherein the collar, shown generally as 110, is not annular. Collar 110 is comprised of a first segment 112 and a second segment 114, segments 112 and 114 also having receiving and projecting formations as at 120, 122, 124 and 126. As shown, collar 110 is generally elliptical when viewed in transverse cross-section. Collar 110 surrounds tubes 22A, 22B and 22C similar to the manner described above with respect to tube 22. Further, there are three temperature sensor assemblies 55 mounted in collar 110 in substantially the same manner as described above with respect to the embodiments of FIGS. 1-8. As in the case of the embodiments described above, apparatus 110 is provided with a sheath 26A constructed in a manner similar to that described above with respect to sheath 26. While the ceramic collar formed by segments 22A and 22B has multiple interengagable formations e.g., 120, 122, 124 and 126, it will be understood that fewer such interengagable formation could be employed and that, indeed, as in the embodiment described above, the abutting surfaces of the segments 112 and 114 could be substantially planar.

While as shown and described above, the connector or connection between temperature sensor assembly 55 and the mount comprises a threaded opening in the mounting plate 82, it will be appreciated that other connectors or connection assemblies may be employed. For example, so-called quick connect or push fit connectors or couplings may be employed as well as other types of connection assemblies well known to those skilled in the art. The only requirement for the connector or connection between the apparatus of the present invention and the temperature sensor assembly is that it possess the ability to hold the probe of the temperature sensor assembly firmly and securely in place on the mount of the apparatus of the present invention.

To the extent possible, it is desired that the end of probe 76, regardless of its nature be as close as possible to the outer surface of the tube 22 so as to obtain the most accurate skin temperature measurement. Thus the mounting assembly of the present invention can be used with various types of thermocouples and temperature sensor assemblies. For example both contact thermocouples and optical thermocouples can be mounted using the apparatus of the present invention. A particularly useful temperature sensor assembly is sold under the trade name Exactus® by BASF. Depending upon the temperature sensor assembly employed, the end of the probe can be spaced from the skin of the tube to be measured or be held against the tube. In the case of temperature sensing assemblies wherein the probe is against the tube, provision is made for expansion of the tubes to prevent damage to the probe.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A mounting apparatus for a temperature sensor assembly for sensing the skin temperature of a tubular member comprising:
a collar made of refractory material in surrounding relationship to said tubular member, said ceramic collar comprising at least two segments, at least one of said segments having a throughbore adapted to receive at least a portion of said temperature sensor assembly; and
a metallic mount removably secured to said collar and having an opening in register with said throughbore, said mount including a connector for attaching to said temperature sensor assembly.

2. The apparatus of claim 1 comprising a selectively removable heat and weather resistant wrap in surrounding relationship to said collar for holding said collar in a fixed position on said tubular member, said wrap having an orifice, said orifice being in register with said throughbore and said opening.

3. The apparatus of claim 2, wherein said wrap comprises an inner layer of a heat resistant fabric, a middle layer of a ceramic fiber and an outer layer of a weather resistant fabric.

4. The apparatus of claim 2, wherein said wrap comprises a fastener for holding said wrap in surrounding relationship to said collar.

5. The apparatus of claim 2 wherein said wrap has first and second ends, there being a first strap around said first end and a second strap around said second end.

6. The apparatus of claim 5 wherein said straps are adjustable.

7. The apparatus of claim 1 wherein said mount comprises a mounting plate and an anchor plate, said mounting plate being removably connected to said anchor plate.

8. The apparatus of claim 7 wherein each of said mounting plate and said anchor plate has an opening, said openings being in register with one another and with said throughbore in said segment of said collar.

9. The apparatus of claim 8 wherein said segment having said throughbore has first and second radially inwardly opening, spaced recesses and there is a first bore extending from said first recess through said segment having said throughbore and there is a second bore extending from said second recess through said segment having said throughbore.

10. The apparatus of claim 9 said anchor plate has first and second holes, said first hole being in register with said bore, said second hole being in register with said bore.

11. The apparatus of claim 10 wherein there is a first bolt received through said first hole and said first bore and connected to a first lock member in said first recess and a second bolt extending though said second hole and said second bore and connected to a second lock member in said second recess.

12. The apparatus of claim 7 wherein said mounting plate is connected to said anchor plate by bolts.

13. The apparatus of claim 8 wherein said connector comprises threads formed in said opening in said mounting plate, said threaded opening being in register with said throughbore in said segment having said throughbore.

14. The apparatus of claim 7 wherein there is a tube connected to said mounting plate and extending into said throughbore in said segment having said throughbore.

15. The apparatus of claim 14 wherein said tube is threadedly connected to said mounting plate.

16. The apparatus of claim 15 wherein said tube forms a well for a temperature sensing probe.

17. The apparatus of claim 1 wherein said tubular member has a circular cross-sectional shape.
